(19) United States
(12) Patent Application Publication
(10) Pub. No.: US 2006/0266863 A1
(43) Pub. Date: Nov. 30, 2006

(54) Recording material supply device

(75) Inventor: Takao Takasu, Saitama (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/407,952

(22) Filed: Apr. 21, 2006

(30) Foreign Application Priority Data
Apr. 22, 2005 (JP) 2005-125017

(51) Int. Cl. G11B 23/107

(52) U.S. Cl. 242/348

(57) ABSTRACT

A recording material supply device for a printer supplies recording material from a roll unit having a recording material roll of the recording material. A drawer portion is movable between open and closed positions, and is depressed and closed in a printer body when in the closed position. Support panels with recesses are secured to the drawer portion, and are loaded with the roll unit when the drawer portion is open, to support the roll unit. Support blocks with channels are secured to the printer body, and are loaded with the roll unit when the drawer portion is in the closed position, for supporting the roll unit in a rotatable manner and positioning the roll unit relative to the printer body. A rotatable feed roller supplies the recording material when the roll unit is supported on the support blocks.

### BACKGROUND OF THE INVENTION

1. Field of the Invention

The present invention relates to a recording material supply device for recording material. More particularly, the present invention relates to a recording material supply device for recording material in which a recording material roll can be loaded by a simple operation and also can be positioned with a sufficiently high precision.

2. Description Related to the Prior Art

A printer for image forming is used with recording material of a sheet or film. A recording material roll is a roll of the recording material with a great length. The recording material is unwounded in the printer from the recording material roll for printing. A recording material supply device is incorporated in or connected with the printer for initial setting of the recording material roll and delivery of the same.

A drawer tray is included in the supply device, and movable relative to a printer body in and out. The recording material roll is set on the drawer tray being set out in its open position, before the drawer tray is moved in toward its closed position, so as to set the recording material roll suitably in the printer body.

A feed roller is incorporated in the supply device for supplying the recording material from the recording material roll. Two structures are conceivable, including a first type in which the feed roller is associated with the drawer tray, and a second type in which the feed roller is in the printer body. According to the first type, problems arise in high complexity of construction of the drawer tray, and much labor in mounting the recording material roll in the drawer tray. The second type is somewhat preferable in view of simplifying manual handling to set the recording material roll.

JP-A 5-097299 and 2002-068537 disclose a known structure in which the recording material roll is kept supported on the drawer tray even though the feed roller is incorporated in the printer body.

While the feed roller is disposed in the printer body, the recording material roll remains supported on the drawer tray which is movable relative from the printer body. It is very difficult to position the recording material roll with the feed roller with high precision. In case of failure of the precise positioning of the recording material roll, the feed roller is likely to cause a problem, for example to advance the recording material in an inclined state.

### SUMMARY OF THE INVENTION

In view of the foregoing problems, an object of the present invention is to provide a recording material supply device for recording material in which a recording material roll can be loaded by a simple operation and also can be positioned with a sufficiently high precision.

In order to achieve the above and other objects and advantages of this invention, a recording material supply device is provided, supplying recording material from a roll unit having a recording material roll of the recording material. A drawer portion is movable between open and closed positions, and is depressed in a printer body and closed when in the closed position, and is loadable with the roll unit when in the open position. A first support mechanism is secured to the drawer portion, for supporting the roll unit set when the drawer portion is in the open position. A second support mechanism is secured to the printer body, for receiving the roll unit from the first support mechanism when the drawer portion is in the closed position, for supporting the roll unit in a rotatable manner. A rotatable feed roller supplies the recording material when the roll unit is supported on the second support mechanism.

The roll unit further includes a roll holder fitted on the recording material roll, and having first and second spindle ends projecting from ends of the recording material roll.

The first support mechanism supports the roll unit in an upward direction, and the roll unit becomes loaded on the second support mechanism by shifting together with the drawer portion toward the closed position.

The first support mechanism includes first and second support panels. First and second support recesses are formed in upper edges of respectively the first and second support panels, for receiving insertion of the roll holder. The second support mechanism includes first and second support blocks. First and second support channels are formed in upper edges of respectively the first and second support blocks, for receiving and supporting the roll holder in a rotatable manner. A support surface is formed with the first and second support blocks to extend in a direction from the first support mechanism toward the first and second support channels, for contacting and supporting the roll holder being moved in shifting the drawer portion toward the closed position.

A supporting level of the first and second support channels for the roll holder is set higher than a supporting level of the first and second support recesses for the roll holder as viewed vertically to shifting of the drawer portion. The support surface is an inclined guide surface for guiding the roll holder toward the first and second support channels in shifting of the drawer portion toward the closed position.

The second support mechanism includes a first biasing portion for pressing the roll holder against the first and second support channels.

The second support mechanism further includes first and second wall panels, positioned at respectively first and second spindle ends of the roll holder. A second biasing portion is disposed on the first wall panel, for pressing the first spindle end in an axial direction, to press the second spindle end toward the second wall panel, and to position the roll unit in the axial direction.

Furthermore, first and second sliding rail portions are disposed on the drawer portion to extend toward the printer body. First and second support rail portions support the first and second sliding rail portions in a slidable manner in the printer body.

### BRIEF DESCRIPTION OF THE DRAWINGS

The above objects and advantages of the present invention will become more apparent from the following detailed description when read in connection with the accompanying drawings, in which:

FIG. 1 is a perspective view illustrating a recording material supply device;

FIG. 2 is an explanatory view in elevation, illustrating main portions of the supply device;

FIG. 3 is a top plan, partially broken, illustrating a lateral plate spring for pressing a roll unit;

FIG. 4A is an explanatory view in elevation, illustrating an initial step of loading of the roll unit which is placed on the support panels;

FIG. 4B is an explanatory view in elevation, illustrating a second step of loading of the roll unit which shifts in contact with the guide surface; and

FIG. 4C is an explanatory view in elevation, illustrating a step of completion of loading of the roll unit by use of the support channels.

### DETAILED DESCRIPTION OF THE PREFERRED EMBODIMENT(S) OF THE PRESENT INVENTION

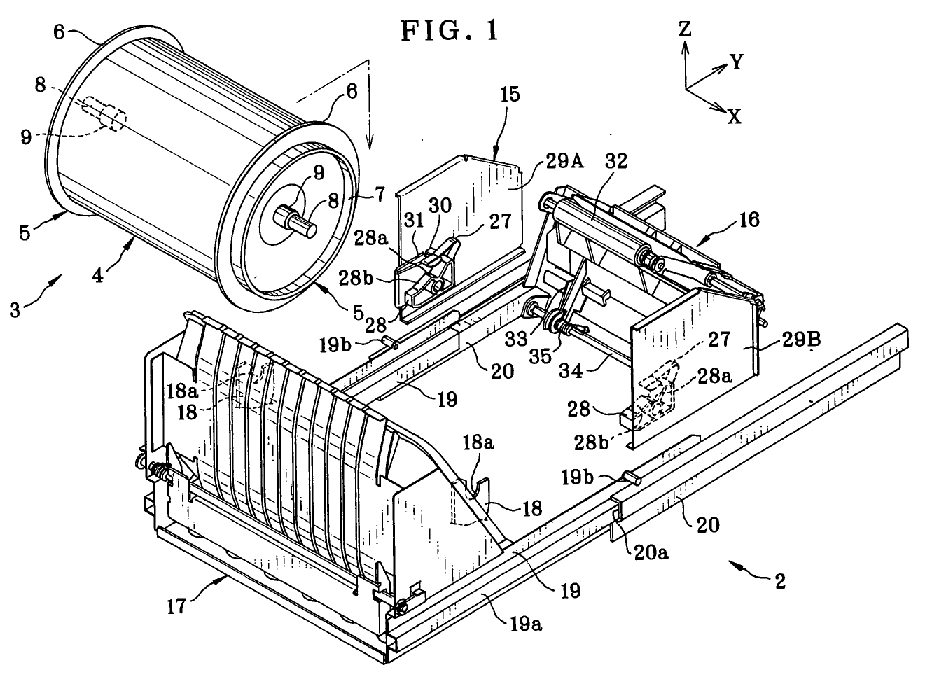

In FIG. 1, a recording material supply device 2 is for use with a printer or image forming apparatus. A roll unit 3 of recording material or recording paper is loaded in the supply device 2, which supplies the recording material. The supply device 2 will be described with the X-Y-Z coordinate system for three dimensions. The X-Y surface is defined to lie parallel with a horizontal plane.

The roll unit 3 includes a recording material roll or recording paper roll 4, and first and second roll holders 5. The recording material roll 4 with a great length is wound in a roll form about a tube shaped core having an axial hole. Each of the roll holders 5 includes a flange 6 and a rotatable spindle 8 as a roll holder spindle. The flange 6 is positioned at an end face of the recording material roll 4. The spindle 8 is rotatable on the flange 6. The flange 6 includes an engaging portion (not shown), a ring shaped grip 7 and a cylindrical portion 9. The engaging portion is fitted on an inner surface of the axial hole of the recording material roll 4. The ring shaped grip 7 is grasped by a user or operator. The cylindrical portion 9 supports the spindle 8 in a rotatable manner. The recording material roll 4 and the flange 6 are combined as a single component and are rotatable together about the spindle 8.

The supply device 2 includes a second support mechanism 15, a feeding mechanism 16, and a drawer tray 17 as drawer portion for material delivery. The second support mechanism 15 is incorporated in a printer body, and supports the roll unit 3 after loading. The feeding mechanism 16 in the printer body feeds the recording material. The drawer tray 17 is movable from a closed position in the printer body to an open position in the direction of the Y axis.

First and second support panels 18 as first support mechanism are disposed in the drawer tray 17, and arranged in the direction of the X axis. First and second support recesses or notches 18a are formed in the support panels 18 in a U shape, and support the rotatable spindle 8 of the roll unit 3. An interval between the support panels 18 is smaller than an interval of the two flanges 6. The spindle 8 at ends of the roll unit 3 is supported by the support recesses 18a of the support panels 18.

First and second sliding rail portions 19 extend from the drawer tray 17. A ridge 19a is formed laterally on each of the sliding rail portions 19 and extends longitudinally. Also, first and second support rail portions 20 are incorporated in the printer body. A channel 20a is formed in the support rail portions 20 and extends longitudinally. The ridge 19a of the sliding rail portions 19 is inserted into the channel 20a of the support rail portions 20, to keep the drawer tray 17 movable in the direction of the Y axis by slide of the ridge 19a in the channel 20a. A locking pin 19b projects from the sliding rail portions 19. A locking mechanism (not shown) is engaged with the locking pin 19b when the drawer tray 17 is moved fully to the closed position in the positive direction of the Y axis, in order to lock the drawer tray 17.

The second support mechanism 15 includes first and second wall panels 29A and 29B, and first and second support blocks 28 retained on the wall panels 29A and 29B. Each of the wall panels 29A and 29B lies parallel with the Y-Z surface, and has an inner face where one of the first and second support blocks 28 is supported. The interval between the wall panels 29A and 29B is slightly greater than a distance between a first spindle end of the rotatable spindle 8 and a second spindle end of the same. The interval between the first and second support blocks 28 is greater than an interval between the first and second support panels 18.

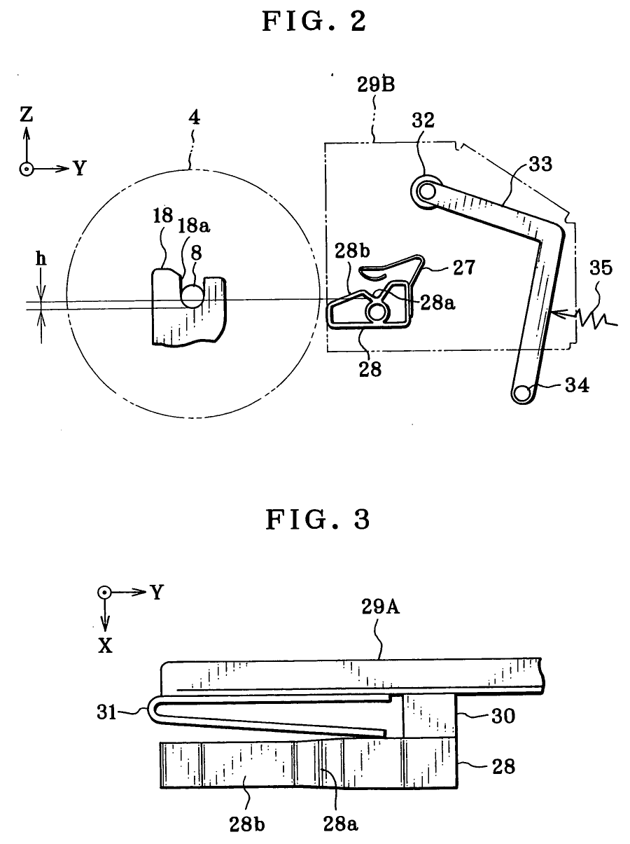

First and second support channels 28a are formed in the first and second support blocks 28, are in a triangular shape, and support the rotatable spindle 8 of the roll unit 3. In FIG. 2, a level of a lowest point of the support channels 28a is higher than a level of a lowest point of the first and second support recesses or notches 18a by an amount h. The spindle 8 of the roll unit 3 is positioned higher when supported by the support channels 28a than when supported by the support recesses 18a. A guide surface 28b as support surface is formed outside the first and second support blocks 28 and positioned on the negative side of the Y axis from the support channels 28a. The guide surface 28b guides the spindle 8 from the support recesses 18a to the support channels 28a with the greater height in transfer of the spindle 8 of the roll unit 3 from the first and second support panels 18 to the first and second support blocks 28. An upper plate spring 27 for biasing as first biasing portion is associated with the first and second support blocks 28, and presses the spindle 8 of the roll unit 3 against the support channels 28a.

In FIG. 3, a spacer 30 and a lateral plate spring 31 for biasing as second biasing portion are disposed between the first wall panel 29A and the first support block 28 on the negative side of the X axis. The first support block 28 on the negative side of the X axis is supported on the first wall panel 29A by the spacer 30. The lateral plate spring 31 is fixedly secured to the first wall panel 29A, and biases the rotatable spindle 8 on the negative side of the X axis during loading of the roll unit 3, to keep the roll unit 3 positioned in the axial direction. Note that the first wall panel 29A is particularly a feature of the invention because of pressure of the spindle 8 on the negative side of the X axis.

In FIG. 1, the feeding mechanism 16 includes a feed roller 32 for material delivery, a retention arm 33, a pivot 34 as printer body, and a driving mechanism (not shown). The retention arm 33 is in an L shape as viewed in section, and supports the feed roller 32 in a rotatable manner. The pivot 34 keeps the retention arm 33 rotatable. The driving mechanism drives the feed roller 32 to rotate. The pivot 34 is disposed in the printer body. A torsion coil spring 35 in the printer body is associated with the pivot 34, and has a first end secured to the pivot 34, and a second end secured to the retention arm 33 at its engagement hole. The retention arm 33 is biased counterclockwise as viewed from the positive side of the X axis.

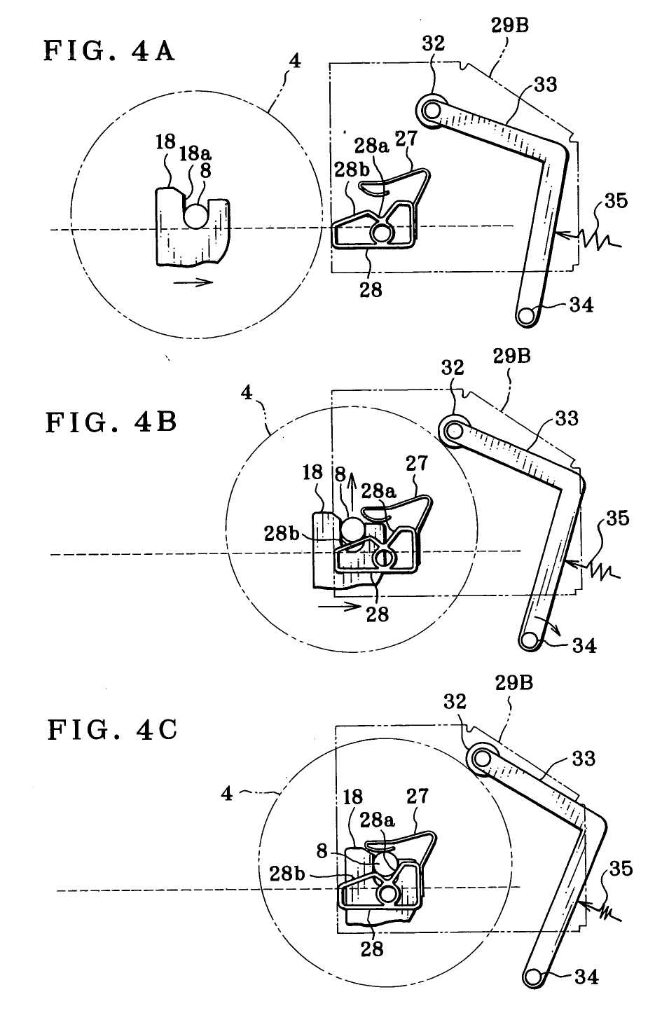

The operation of the embodiment is described with reference to FIGS. 1 and 4A-4C. When the drawer tray 17 is drawn out in the negative direction of the Y axis, the roll unit 3 being used is removed. The drawer tray 17 is ready to be loaded with the roll unit 3 being unused.

The rotatable spindles 8 at ends of the roll unit 3 are supported in the first and second support recesses or notches 18a of the first and second support panels 18 so the roll unit 3 can be mounted on the drawer tray 17. The roll unit 3 is positioned with reference to only the Y axis relative to the drawer tray 17. In FIG. 4A as a side elevation, the supply device 2 is viewed on the positive side of the X axis. The retention arm 33 is biased counterclockwise about the pivot 34.

When the drawer tray 17 is pushed in the positive direction of the Y axis, a spindle end of the rotatable spindle 8 (See FIG. 1) on the negative side of the X axis contacts the lateral plate spring 31. The roll unit 3 receives force in the positive direction of the X axis. The spindle end of the spindle 8 on the positive side of the X axis is pressed against a lateral face of the second wall panel 29B, to keep the roll unit 3 positioned relative to the printer body in the X axis.

When the drawer tray 17 is further moved in the closing direction, the peripheral surface of the rotatable spindle 8 contacts the guide surface 28b of the first and second support blocks 28. In FIG. 4B, the spindle 8 receives force in the positive direction on the Z axis, and moves away from the lowest point of the first and second support recesses 18a of the first and second support panels 18 to move in contact with the guide surface 28b of the first and second support blocks 28. In the course of this movement, the peripheral surface of the recording material roll 4 of the roll unit 3 contacts the feed roller 32.

In FIG. 4C, the rotatable spindle 8 shifted with the guide surface 28b contacts the upper plate spring 27 and is pushed in the negative direction of the Z axis, before entry into the first and second support channels 28a of the first and second support blocks 28. The spindle 8 is pressed against an edge of the support channels 28a, to position the roll unit 3 relative to the printer body in the Y and Z axes. During this movement, the recording material roll 4 pushes back the feed roller 32 against a spring. The feed roller 32 is pressed against the peripheral surface of the recording material roll 4. Thus, the roll unit 3 becomes loaded in the printer body finally.

When the drawer tray 17 is shifted fully to the closed position, locking with the locking pin 19b is enabled. Locking with the locking pin 19b is maintained during the image recording, to prevent the drawer tray 17 from movement toward the open position.

After completion of loading of the roll unit 3, a driving mechanism (not shown) causes the feed roller 32 to rotate, to deliver the recording material from the roll unit 3 into the printer body. An image is recorded on the recording material. A printed region of the recording material is cut away and is exited from the printer body.

When the recording material of the recording material roll 4 of the roll unit 3 are all used up, the drawer tray 17 is drawn to the open position, to replace the roll unit 3 being used with an unused roll unit 3. At first, the movement of the drawer tray 17 in the opening direction is started. The rotatable spindle 8 receives force from the first and second support panels 18 in the negative direction of the Y axis, and is moved away from the first and second support channels 28a and to the guide surface 28b. The drawer tray 17 is further moved, so the spindle 8 shifts in contact with the guide surface 28b, and then moves away from the guide surface 28b. Thus, the spindle 8 becomes supported on the first and second support recesses 18a. When the drawer tray 17 is fully drawn to come in the open position, then removal of the roll unit 3 being used is enabled.

According to the invention, the feed roller 32 is disposed in the printer body and not in the drawer tray 17. The loading of the roll unit 3 is facilitated by simply constructing the drawer tray 17. Also, the first and second support blocks 28 receive the roll unit 3 having been received on the first and second support panels 18. It is possible the roll unit 3 with high precision relative to the printer body and the feed roller 32. This is effective in failure in the feeding, such as an inclined feeding.

In the above embodiment, the first and second roll holders 5 are a pair. However, the recording material roll 4 to be held has a tubular shape with an axial hole. A single roll holder of a rod shape can be inserted through the axial hole of the recording material roll 4.

In the above embodiment, the X-Y surface is parallel with a horizontal plane. However, the X-Y surface may be inclined slightly relative to the horizontal plane in a range enabling the transfer of the roll unit 3.

It is noted that the recording material roll 4 of the invention may be any type in the field of image forming. A printer for use with this may be any one of various printers, such as thermal printer, photographic printer, ink jet printer and the like.

Although the present invention has been fully described by way of the preferred embodiments thereof with reference to the accompanying drawings, various changes and modifications will be apparent to those having skill in this field. Therefore, unless otherwise these changes and modifications depart from the scope of the present invention, they should be construed as included therein.

What is claimed is:

1. A recording material supply device for supplying recording material from a roll unit having a recording material roll of said recording material, comprising:
a drawer portion, movable between open and closed positions, and being depressed in a printer body and closed when in said closed position, and being loadable with said roll unit when in said open position;
a first support mechanism, secured to said drawer portion, for supporting said roll unit set when said drawer portion is in said open position;
a second support mechanism, secured to said printer body, for receiving said roll unit from said first support mechanism when said drawer portion is in said closed position, for supporting said roll unit in a rotatable manner; and
a rotatable feed roller for supplying said recording material when said roll unit is supported on said second support mechanism.

2. A recording material supply device as defined in claim 1, wherein said roll unit further includes a roll holder fitted on said recording material roll, and having first and second spindle ends projecting from ends of said recording material roll.

3. A recording material supply device as defined in claim 2, wherein said first support mechanism supports said first and second spindle ends of said roll unit in an upward direction, and said roll unit becomes loaded on said second support mechanism by shifting together with said drawer portion toward said closed position.

4. A recording material supply device as defined in claim 3, wherein (A) said first support mechanism includes:
first and second support panels;
first and second support recesses, formed in upper edges of respectively said first and second support panels, for receiving insertion of said first and second spindle ends of said roll holder;
(B) said second support mechanism includes:
first and second support blocks;
first and second support channels, formed in upper edges of respectively said first and second support blocks, for receiving and supporting said first and second spindle ends of said roll holder in a rotatable manner; and
a support surface, formed with said first and second support blocks to extend in a direction from said first support mechanism toward said first and second support channels, for supporting said first and second spindle ends of said roll holder being moved in shifting said drawer portion toward said closed position.

5. A recording material supply device as defined in claim 4, wherein a supporting level of said first and second support channels for said first and second spindle ends of said roll holder is set higher than a supporting level of said first and second support recesses for said roll holder as viewed vertically to shifting of said drawer portion;
said support surface is an inclined guide surface for guiding said first and second spindle ends of said roll holder toward said first and second support channels in shifting of said drawer portion toward said closed position.

6. A recording material supply device as defined in claim 4, wherein said second support mechanism includes a first biasing portion for pressing said first and second spindle ends of said roll holder against said first and second support channels.

7. A recording material supply device as defined in claim 6, wherein said second support mechanism further includes:
first and second wall panels, positioned at faces of respectively said first and second spindle ends of said roll holder;
a second biasing portion, disposed on said first wall panel, for pressing a face of said first spindle end in an axial direction, to position said roll unit in said axial direction.

8. A recording material supply device as defined in claim 1, further comprising:
first and second sliding rail portions disposed on said drawer portion to extend toward said printer body; and
first and second support rail portions for supporting said first and second sliding rail portions in a slidable manner in said printer body.
